(19) United States
(12) Patent Application Publication
(10) Pub. No.: US 2026/0186915 A1
(43) Pub. Date: Jul. 2, 2026

(54) RECOVERING LAYERS OF A CONTAINER

(71) Applicant: International Business Machines Corporation, Armonk, NY (US)

(72) Inventors: Xiao Ling Chen, Beijing (CN); Wen Ji Huang, Beijing (CN); Si Yu Chen, Beijing (CN); Qi Li, Beijing (CN)

(21) Appl. No.: 18/742,064

(22) Filed: Jun. 13, 2024

(51) Int. Cl. G06F 11/1446

(52) U.S. Cl. CPC G06F 11/1469

(57) ABSTRACT

Examples described herein provide a computer-implemented method that includes downloading a container image from an image repository. The method further includes deploying the container image as a container at a local graph. The method further includes identifying an image layer of the container image of the container as having a patch in error. The method further includes marking, at the image repository, the image layer as having the patch in error by modifying attributes of a manifest configuration for the image layer having the patch in error. The method further includes rolling back the image layer of the container having the patch in error to a parent image layer based on the attributes of the manifest configuration for the image layer having the patch in error.

### BACKGROUND

The present disclosure relates to computing systems, and more specifically, to recovering layers of a container.

Containers provide an application layer approach to virtualization. A container packages together code and its dependencies, and the container can be run on a physical processing system. Multiple containers can be run on the same physical processing system. This approach uses less resources than a virtual machine approach to virtualization.

### SUMMARY

According to an embodiment, a computer-implemented method for recovering layers of a container is provided. The method includes downloading a container image from an image repository. The method further includes deploying the container image as a container at a local graph. The method further includes identifying an image layer of the container image of the container as having a patch in error. The method further includes marking, at the image repository, the image layer as having the patch in error by modifying attributes of a manifest configuration for the image layer having the patch in error. The method further includes rolling back the image layer of the container having the patch in error to a parent image layer based on the attributes of the manifest configuration for the image layer having the patch in error.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIGS. 2A and 2B illustrate an image and a container, each with layers, according to an embodiment;

FIG. 3 illustrates a diagram of an architecture for recovering layers of a container using a patch in error layer recovery (PELR) engine and a patch in error manifest updater (PEMU) engine, according to an embodiment;

FIG. 4 illustrates a manifest for a layer of an image, according to an embodiment;

FIG. 5 illustrates an architecture for recovering layers of a container using the PEMU engine, according to an embodiment;

FIG. 6 illustrates an architecture for recovering layers of a container using the PELR engine, according to an embodiment;

FIG. 7 illustrates a flow diagram of a method for updating the attributes of a layer's manifest configuration and pushing the updated manifest configuration to a remote repository, according to an embodiment; and

FIG. 8 illustrates a flow diagram of a method for recovering layers of a container, according to an embodiment.

The detailed description explains embodiments of the disclosure, together with advantages and features, by way of example with reference to the drawings.

### DETAILED DESCRIPTION

One or more embodiments described herein relate to recovering layers of a container.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

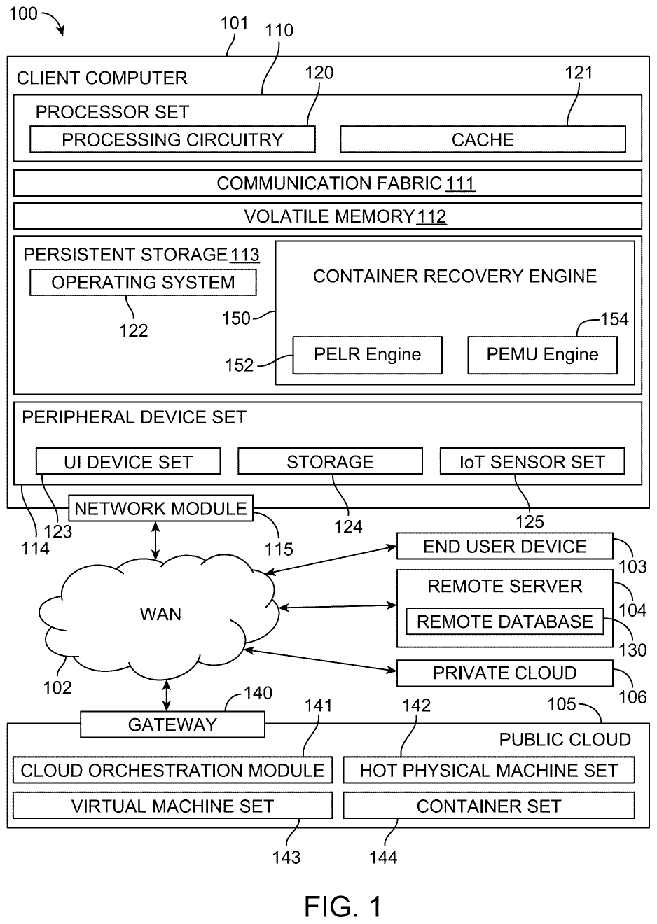

FIG. 1 illustrates a computing environment 100, according to an embodiment. Computing environment 100 contains an example of an environment for the execution of at least some of the computer code involved in performing the inventive methods, such as a container recovery engine 150, which may be used for recovering layers of a container. The container recovery engine 150 may include a patch in error layer recovery (PELR) engine 152 and a patch in error manifest updater (PEMU) engine 154. In addition to container recovery engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and container recovery engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in container recovery engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in container recovery engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Containers package together code and its dependencies to provide for virtualization. Some approaches to implementing containers involve packaging the contents of image layers into an image and pushing the image to an image repository. The image can then be pulled from the image repository to be implemented on other systems, such as by end users. When pulling an image from the image repository, the contents of the image layers and any parent layers for the image are downloaded to a local graph. The local graph (also referred to as a “local graph node”) is a structure used for managing and visualizing dependencies, relationships, and/or states of Docker containers and services within a local environment (e.g., a user's production environment). The local graph is managed by the Docker daemon (e.g., Dockerd), and the Docker command line interface (CLI) can be used to interact with the local graph. For example, the Docker CLI can be used to list images, create containers, remove containers and images, inspect images and containers, and more. Once downloaded, the image can be stored on a local graph and deployed as a container. In other words, the layers of the image are uploaded to the image repository and then those layers are later downloaded to one or more local graphs for deployment as a container.

In some cases, patches may be released to fix bugs or add functionality to an image. For example, after an image is released (e.g., uploaded to the image repository), an error may be identified in the image, and a patch may be released to address the error. In such cases, a patch itself may have an error, which is referred to as a “patch in error.” It is often not possible for a user to remove the patch in error immediately if a higher version is used in the user's production environment. If a higher version (e.g., layer 8 (L8)) was exploited on a user's production environment, it is not possible for the user to remove the layer 5 (L5) with the patch in error from the exploited customers. For example, to fix an issue identified in an older layer (e.g., layer 3 (L3)) of an image, a fix patch can be delivered on a newer layer (e.g., layer 5 (L5)) of the image. It may be discovered thereafter that the fixes on the newer layer (e.g., L5) trigger other errors, thus the original patch was a patch in error.

A situation may occur where a higher version of the image is used (e.g., a top layer of a user's environment is layer 8 (L8) in which L5 includes the patch in error followed by layers 6 and 7 (L6 and L7). In such cases, there are two options for the user: wait for the availability of L5 fixes (which may take several months to receive, for example) or to redeploy a lower safe version (e.g., the version for layer 4 (L4) or lower) and abandon the newer functions or fixes on the higher layers (e.g., L6 and L7). Neither of these approaches is desirable due to the delay and loss of fixes and functionality (which may impact security vulnerability exposure, for example), respectively.

One or more embodiments described herein address these and other shortcomings by providing for recovering layers of a container. Such one or more embodiments ensure better use of product capabilities, automation, and resiliency insights by recovering the patches in error in a container environment. More particularly, one or more embodiments described herein provide for updating a manifest list of an image repository with real-time patch in error information, including a “manPatchHealthStatus” indicator and a “manLowerLayerID” indicator. A single manifest includes information about an image, such as its size, layers, and digest. A manifest list is a list of image layers (e.g., “manifests” or “manifest items”) that are created by specifying one or more image names. Then, the layers without the patches in error are pulled to help user promote the robustness of the enterprise-level production environments as soon as possible and avoid security vulnerability exposure as much as possible. One or more embodiments provides for users to recover the patches in error without waiting long periods for the fixes and without sacrificing the new features following the patches in error. Moreover, one or more embodiments are transparent to both the developers of the image and the end users.

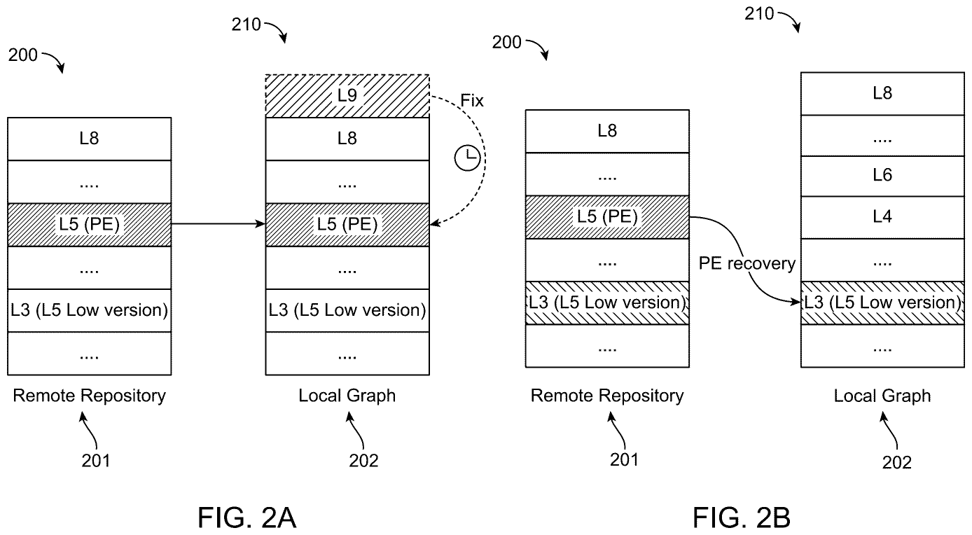

According to one or more embodiments described herein, a method is provided to recover the layers of an image with patch in error quickly based on real-time patch health status “manPatchHealthStatus” and “manLowerLayerID” updated into the manifest list to ensure better use of product capabilities, automation and resiliency insights. As used herein, “manPatchHealthStatus” is the patch health status, including “normalPatch” and “PatchInError,” of a patch, and “manLowerLayerID” is used to store the layer image identifier (ID) of the lower layer without the patch in error. According to one or more embodiments, a container command “set layer as PE” is used to set the specified layer as the patch in error on the manifest file of the repository remotely. According to one or more embodiments, the users are enabled to be notified of the patch in error and to choose whether to recover or pull the layer with patch in error during deploying the container. According to one or more embodiments, a “Patch in Error Manifest Updater” engine (e.g., the PEMU engine 154) is introduced into a graph driver to update the attributes of a layer's manifest configuration “manPatchHealthStatus” and “manLowerLayerID” and then push the updated manifest to the repository. A graph driver enables a union file system. Graph drivers (also referred to as “storage drivers”) are used when dealing with layered container images, such as those depicted in FIGS. 2A and 2B). A graph driver consolidates the multiple image layers into a root file system for the mount namespace of the container. That is, the graph driver controls how images and containers are stored and managed on a Docker host. According to one or more embodiments, a “Patch in Error Layer Recovery” engine (e.g., the PELR engine 152) is introduced into the graph driver to pull the layers without the patch in error by checking “manPatchHealthStatus” of the layer's manifest and setting the layer with “manLowerLayerID” as the next target layer.

Turning now to FIGS. 2A and 2B, a container image 200 and a container 210, each with layers, are shown, according to an embodiment. The container image 200 is stored in an image repository 201 and can be downloaded to and installed on a local graph 202 as the container 210. A container image (e.g., the container image 200) is a standalone executable software package that includes the information needed to run a piece of software, including the code, runtime, system tools, libraries, and settings. Container images are used to create containers, which are instances of the container images running as isolated processing on a host operating system (e.g., the operating system 122). For example, the container image 200 is used to create the container 210. According to an embodiment, the container 210 in FIGS. 2A and 2B is a container image pulled from the image repository 201 to the local graph 202. According to another embodiment, consider the following example. Docker mounts layers (e.g., a base layer, layer L1, . . . Layer L7, Layer L8) at one mount point. These are called image layers, and the container 210 exploited with this image can share the image layers (e.g., read-only layers) and have their own container layer (read-write layer). For example, Docker runs three containers C1, C2, C3 with image I1, then the containers C1, C2, C3 share the image layers of I1, which is stored in local graph 202 as the container 210 shown.

In FIG. 2A, the container image 200 and the container 210 are shown as having multiple layers, including layers L3, L5, and L8, among others. In FIG. 2B, the container image 200 and the container 210 are also shown as having multiple layers, including layers L3, L4, L5, L6, and L8, among others.

If a patch in error (PE) is deployed to one of the layers (e.g., to the layer L5 as shown in FIG. 2A), it may take time for a new fix to be implemented as a new layer of the container 210 of FIG. 2A (e.g., layer L9). In some cases, the new layer (e.g., layer L9) may take weeks or even months to be implemented, thus causing the container 210 to function improperly (e.g., using the patch in error at layer L5) until the fix is implemented. As shown in FIG. 2B, rather than waiting for a new layer (e.g., the layer L9) to be implemented to fix the issue(s) identified in an older layer (e.g., layer L5), one or more embodiments described herein provide for performing patch in error recovery to recover the layers of the container 210 with patch in error (e.g., the layer L5) quickly based on real-time patch health status “manPatchHealthStatus” and “manLowerLayerID” updated into the manifest as further described herein with reference FIG. 3, for example. The updated “manPatchHealthStatus” and “manLowerLayerID” attributes provide for rolling back the layer of the container having the patch in error (e.g., layer L5) to a parent image layer (e.g., layer L4).

FIG. 3 illustrates a diagram of an architecture 300 for recovering layers of a container using the PELR) engine 152 and the PEMU engine 154, according to an embodiment. As described herein, an attribute “manPatchHealthStatus” is introduced to the manifest configuration (also referred to simply as “manifest”) of the image (e.g., the container image 200) and includes two status types “normalPatch” and “PatchInError” (PE). The normalPatch status type indicates a normal patch without error, and the PatchInError status type indicates a patch in error.

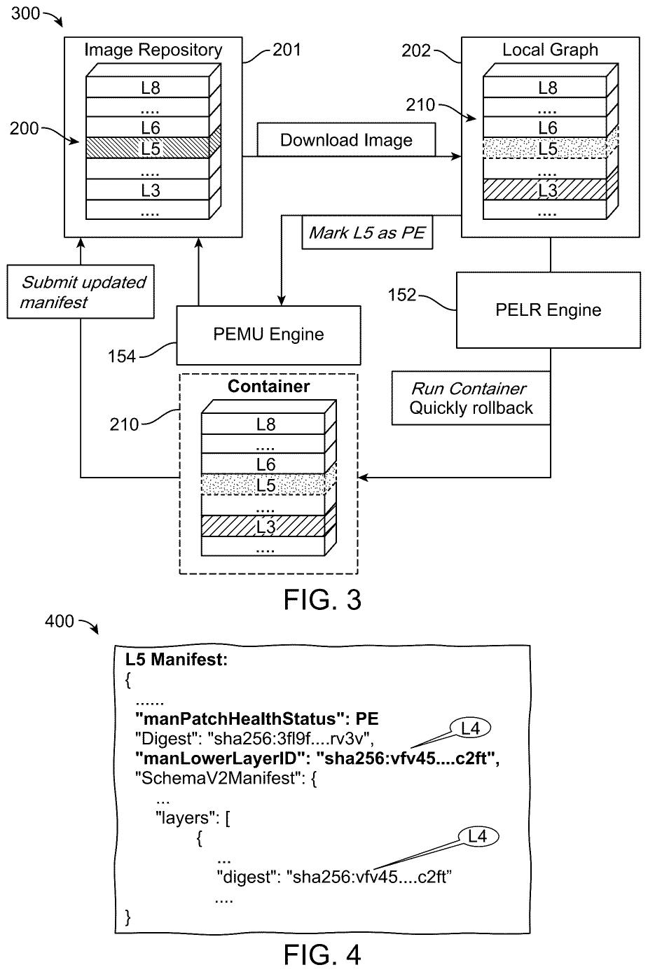

As shown in FIG. 3, the container image 200 is downloaded from the image repository 201 to the local graph 202 and installed as the container 210 at the local graph 202. In this example, the layer L5 is identified as a patch in error, and the layer L3 is the target of the patch in error. The PEMU engine 154 marks the layer L5 as the patch in error, which is reflected in the container image 200 of the image repository 201 using the manifest 400 shown in FIG. 4. The PELR engine 152 can quickly roll back the container 210 using the “manLowerLayerID” identifier, which identifies the layer image ID of the lower layer (e.g., the layer L4) without the patch in error using the manifest 400. In particular, manifest 400 includes the manPatchHealthStatus indicator and includes two status types: normalPatch and PatchInError as described herein. In the example of FIG. 3, the layer L5 is the fix of the layer L3 and thus is the patch in error. The manifest 400 includes the manLowerLayerID, which is the layer image ID of the lower layer without the patch in error. In the example of FIG. 3, the layer L4 is the lower layer without the patch in error for the layer L5.

The PEMU engine 154 is used to update the attributes of the layer's manifest configuration, manPatchHealthStatus and manLowerLayerID, then push the updated manifest (e.g., the manifest 400) to the image repository 201. The PEMU engine 154 can be triggered by a container command “set layer as PE.”

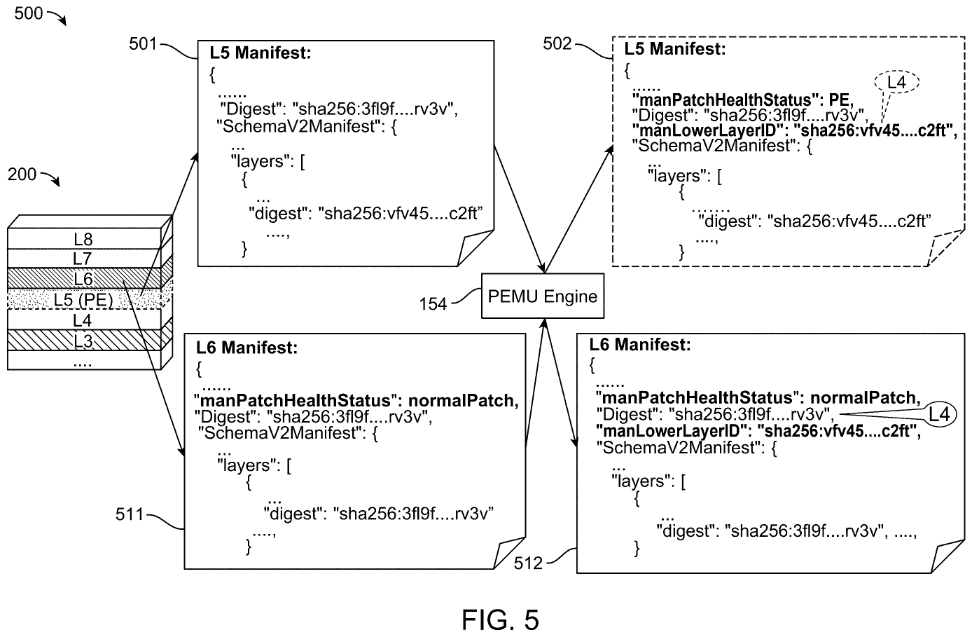

FIG. 5 illustrates an architecture 500 for updating the manifest of a layer with patch in error using the PEMU engine 154, according to an embodiment. In this example, container 210 has a top layer of layer L8. The layer L5 is the patch in error and also fixes the layer L3. The PEMU engine 154 is triggered using the command “set L5 as PE.” In response to the command, the PEMU engine 154 updates an initial layer L5 manifest 501 to generate an updated layer L5 manifest 502 by updating the manPatchHealthStatus to “PatchInError” and updating the manLowerLayerID to L4_Digest (L4's image ID). A “digest” refers to the “image ID” for a layer. According to one or more embodiments, Docker uses a content-addressable image store, and the image ID is a SHA256 digest covering the image's configuration and layers. Similarly, the PEMU engine 154 updates an initial layer L6 manifest 511 to generate an updated layer L6 manifest 512 by updating the manLowerLayerID to L4_Digest (L4's image ID). The updated manifests for the layers L5 and L6 (e.g., the updated layer L5 manifest 502 and the updated layer L6 manifest 512) for the container 210 are then sent to the image repository 201 for inclusion in the container image 200.

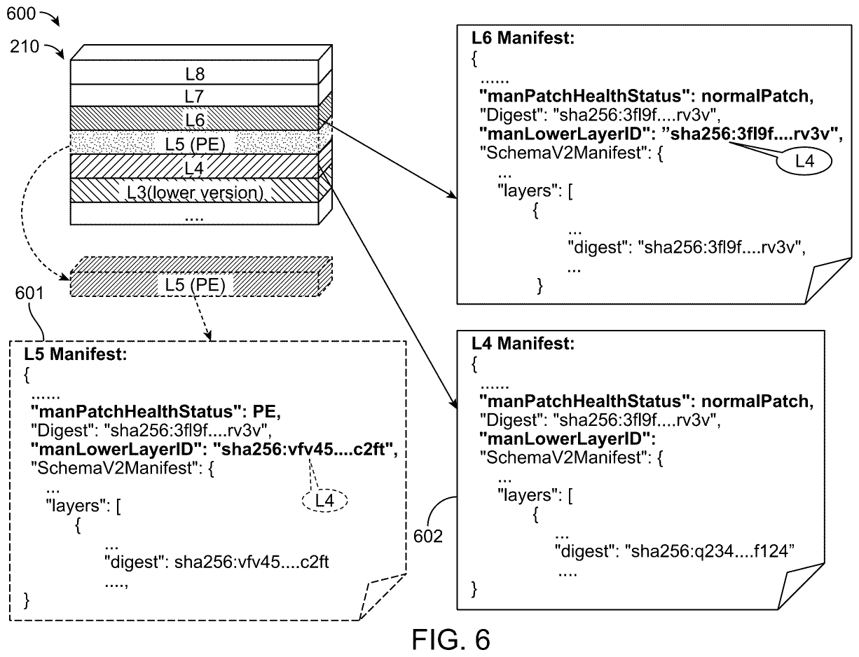

FIG. 6 illustrates an architecture 600 for recovering layers of the container 210 using the PELR engine 152, according to an embodiment. The PELR engine 152 is used to roll back a lower version quickly without waiting for a corrected version of the container image 200. That is, the PELR engine 152 rolls back the lower version without waiting for a new image layer to be created that fixes the errors resulting from the previous patch in error of image layer L5. In this example, the layer L5 is marked as the patch in error in the PEMU engine 154 as described herein. If the attribute manLowerLayerID is not NULL (as shown in the L5 manifest 601) then the PELR engine 152 pulls the lower (parent) layer with the layer image ID stored in the manLowerLayerID. Otherwise (e.g., as shown in the L4 manifest 602), the parent layer stored in the SchemaV2Manifest is pulled. If the manPatchHealthStatus of the target layer L5 is patch in error (as shown in the L5 manifest 601), then the user is reminded it is a patch in error and the user is prompted to continue to pull it or not.

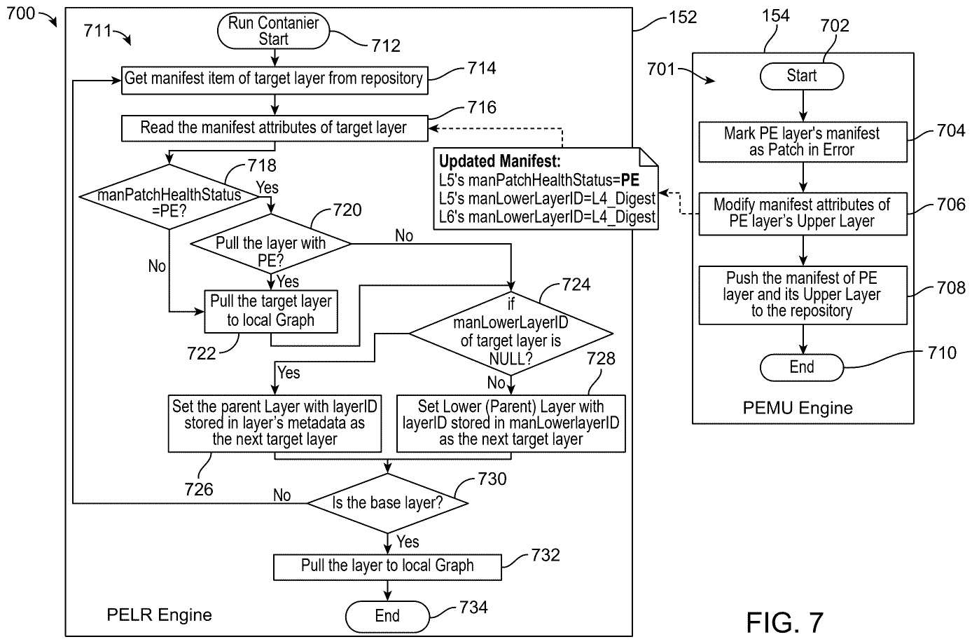

Turning now to FIG. 7, a flow diagram of a method 700 for recovering layers of a container is provided, according to an embodiment. The method 700 can be performed by any suitable computing system, device, or environment, such as those described herein (e.g., the computing environment 100 and/or the computer 101 of FIG. 1). According to one or more embodiments, the method 700 is performed, in whole or in part, using container recovery engine 150 (including one or more of the PELR engine 152 and the PEMU engine 154) of FIG. 1.

It should be appreciated that the method 700 is described with respect to the functions of the PEMU engine 154 and the PELR engine 152. In this regard, the method 700 includes two sub-methods, referred to as method 701 and method 711. The method 701 is performed by the PEMU engine 154 and the method 711 is performed by the PELR engine 152.

The method 701 begins at block 702 and proceeds to block 704. At block 704, the PEMU engine 154 receives the manifest of a layer with patch in error and sets manPatchHealthStatus as PatchInError (e.g., layer L5's manPatchHealthStatus=PE) by triggering the command “set layer as PE.” At block 706, the PEMU engine 154 updates manLowerLayerID of the patch in error's next higher layer (e.g. layer L6's manLowerLayerID=L4_digest) and the manifest attributes manLowerLayerID of the patch in error layer (e.g., layer L5's manLowerLayerID=L4_Digest). The next higher layer is a parent layer's parent layer. For example, if layer L5 is the layer with patch in error, the lower layer identifier (e.g., “manLowerLayerID”) of layer L6 is set to the image ID of layer L4. The lower layer identifier is the manifest attribute manLowerLayerID and is defined by the layer ID of the lower layer without patch in error. The value of the lower layer identifier is the same as a “parent layer” if the parent layer is not a patch in error. If the parent layer is a patch in error, then the value of the lower layer identifier (manLowerLayerID) is the parent layer's parent layer. At block 708, PEMU engine 154 sends the updated manifests to the patch in error layer and its higher layer (e.g., layers L5 and L6, respectively) to the image repository 201. The method 701 then terminates at block 710.

The method 711 begins at block 712 and proceeds to block 714. At block 714, the PELR engine 152 receives a manifest item of a target layer from the image repository 201. At block 716, the PELR engine 152 reads the manifest attributes of the target layer from the PEMU engine 152. At block 718, the PELR engine 152 checks the manifest's attribute manPatchHealthStatus to determine whether it is set to PatchInError. If so (block 718 “Yes”), the PELR engine 152 prompts the user whether to pull the patch in error layer to the local graph 202 or not at block 720. If the user selects to pull the patch in error layer to the local graph (block 720 “Yes”), or if the manPatchHealthStatus is not set to PatchInError, (block 718 “No”), the PELR engine 152 pulls the target layer to the local graph 211. If the user selects not to pull the layer with the patch in error (block 720 “No”) or subsequent to pulling the target layer to the local graph 211 (block 722), the PELR engine 152 determines whether the layer's manifest attribute manLowerLayerID is NULL or not. If so (block 724 “Yes”), the PELR engine 152 sets the parent layer with the layer image ID stored in the layer's metadata as the next target layer at block 726. If not (block 724 “No”), the PELR engine 152 sets the lower (parent) layer with the layer image ID stored in the manLowerLayerID as the next target layer at block 728. The method 711 proceeds to block 730 to determine whether the next target layer is the base layer or not. If not (block 730 “No”), the method 711 returns to block 714 and repeats. If so (block 730 “Yes”), the PELR engine 152 pulls the target layer to the local graph 202 at block 732. The method 711 then terminates at block 734.

Additional processes also may be included, and it should be understood that the processes depicted in FIG. 7 represent illustrations, and that other processes may be added or existing processes may be removed, modified, or rearranged without departing from the scope of the present disclosure. It should also be understood that the processes depicted in FIG. 7 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

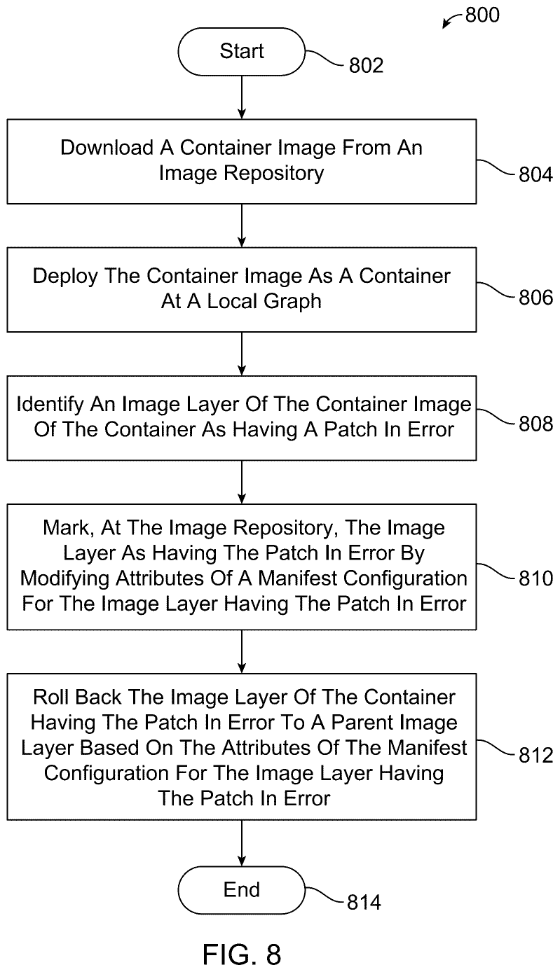

Turning now to FIG. 8, a flow diagram of a method 800 for recovering layers of a container is provided, according to an embodiment. The method 800 can be performed by any suitable computing system, device, or environment, such as those described herein (e.g., the computing environment 100 and/or the computer 101 of FIG. 1). According to one or more embodiments, the method 800 is performed, in whole or in part, using container recovery engine 150 (including one or more of the PELR engine 152 and the PEMU engine 154) of FIG. 1.

The method 800 begins at block 802. At block 804, the container image 200 is downloaded (e.g., by the computer 101) from the image repository 201. At block 806, the container image 200 is deployed (e.g., on the computer 101) as the container 210 at the local graph 202. At block 808, the PEMU engine 154 identifies an image layer (e.g., the layer L5) of the container image 200 of the container 210 as having a patch in error. At block 810, the PEMU engine 154 marks, at the image repository 201, the image layer (e.g., the layer L5) as having the patch in error by modifying attributes of a manifest configuration (e.g., the manifest 400) for the image layer having the patch in error. For example, the manifest configuration is modified by setting a manPatchHealthStatus for the layer to be PatchInError and by setting an manLowerLayerID for the layer to point to a next target layer (e.g., a parent layer). At block 810, the PELR engine 152 rolls back the image layer of the container 210 having the patch in error (e.g., the layer L5) to a parent image layer (e.g., the layer L4) based on the attributes of the manifest configuration for the image layer having the patch in error. For example, the PELR engine 152 rolls back the image layer of the container to the parent image layer (e.g., the layer L4) denoted in manLowerLayerID of the manifest configuration.

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein allows users to recover the layer with patches in error with more flexibility and efficiency without waiting for fixes and without sacrificing the new features following the patches in error. According to one or more embodiments, both developers and users can easily maintain and upgrade the whole environment without the need for extra work to consider the negative impact of the patches in error. One or more embodiments described herein is compatible with current container tools, such as Docker, Podman, and/or the like, including combinations and/or multiples thereof.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
rolling back the image layer of the container having the patch in error to a parent image layer based on the attributes of the manifest configuration for the image layer having the patch in error.

2. The computer-implemented method of claim 1, wherein modifying the attributes of the manifest configuration for the image layer having the patch in error comprises setting a status in the manifest layer for the image layer having the patch in error to a patch in error status.

3. The computer-implemented method of claim 1, wherein modifying the attributes of the manifest configuration for the image layer having the patch in error comprises setting a lower layer identifier for the image layer having the patch in error to point to the parent image layer.

4. The computer-implemented method of claim 1, wherein modifying the attributes of the manifest configuration for the image layer having the patch in error comprises:
setting a status for the image layer having the patch in error to a patch in error status; and
setting a lower layer identifier for the image layer having the patch in error to point to the parent image layer.

5. The computer-implemented method of claim 1, further comprising submitting the manifest configuration to the image repository subsequent to modifying the attributes of the manifest configuration for the image layer having the patch in error.

6. The computer-implemented method of claim 1, further comprising modifying a lower layer identifier of a next higher layer of the container to point to the parent image layer.

7. The computer-implemented method of claim 1, further comprising prompting a user of the container that the image layer of the container contains a patch in error.

8. A system comprising:
a memory comprising computer readable instructions; and
a processing device for executing the computer readable instructions, the computer readable instructions controlling the processing device to perform operations comprising:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
rolling back the image layer of the container having the patch in error to a parent image layer based on the attributes of the manifest configuration for the image layer having the patch in error.

9. The system of claim 8, wherein modifying the attributes of the manifest configuration for the image layer having the patch in error comprises setting a status in the manifest layer for the image layer having the patch in error to a patch in error status.

10. The system of claim 8, wherein modifying the attributes of the manifest configuration for the image layer having the patch in error comprises setting a lower layer identifier for the image layer having the patch in error to point to the parent image layer.

11. The system of claim 8, wherein modifying the attributes of the manifest configuration for the image layer having the patch in error comprises:
setting a status for the image layer having the patch in error to a patch in error status; and
setting a lower layer identifier for the image layer having the patch in error to point to the parent image layer.

12. The system of claim 8, wherein the operations further comprise submitting the manifest configuration to the image repository subsequent to modifying the attributes of the manifest configuration for the image layer having the patch in error.

13. The system of claim 8, wherein the operations further comprise modifying lower layer identifier of a next higher layer of the container to point to the parent image layer.

14. The system of claim 8, wherein the operations further comprise prompting a user of the container that the image layer of the container contains a patch in error.

15. A computer program product comprising:
a set of one or more computer-readable storage media;
program instructions, collectively stored in the set of one or more storage media, for causing a processor set to perform the following computer operations:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
rolling back the image layer of the container having the patch in error to a parent image layer based on the attributes of the manifest configuration for the image layer having the patch in error.

16. The computer program product of claim 15, wherein modifying the attributes of the manifest configuration for the image layer having the patch in error comprises setting a status in the manifest layer for the image layer having the patch in error to a patch in error status.

17. The computer program product of claim 15, wherein modifying the attributes of the manifest configuration for the image layer having the patch in error comprises setting a lower layer identifier for the image layer having the patch in error to point to the parent image layer.

18. The computer program product of claim 15, wherein modifying the attributes of the manifest configuration for the image layer having the patch in error comprises:
setting a status for the image layer having the patch in error to a patch in error status; and
setting a lower layer identifier for the image layer having the patch in error to point to the parent image layer.

19. The computer program product of claim 15, wherein the operations further comprise submitting the manifest configuration to the image repository subsequent to modifying the attributes of the manifest configuration for the image layer having the patch in error.

20. The computer program product of claim 15, wherein the operations further comprise modifying lower layer identifier of a next higher layer of the container to point to the parent image layer.
